(19) United States
(12) Patent Application Publication
(10) Pub. No.: US 2012/0296472 A1
(43) Pub. Date: Nov. 22, 2012

(54) FORCE CONTROL ROBOT

(75) Inventor: Masayuki Nagai, Tokyo (JP)

(73) Assignee: CANON KABUSHIKI KAISHA, Tokyo (JP)

(21) Appl. No.: 13/575,056

(22) PCT Filed: Dec. 3, 2010
(86) PCT No.: PCT/JP2010/007054

§ 371 Date: Jul. 25, 2012

(30) Foreign Application Priority Data
Mar. 24, 2010 (JP) 2010-068015

(51) Int. Cl. B25J 13/08; B25J 9/16

(52) U.S. Cl. 700/258

(57) ABSTRACT

A force control robot which controls a motion of a robotic arm based on a detection value of a force detector, the force control robot including: the robotic arm having one end as a fixed end and another end as a movable end; an end effector connected to the movable end of the arm through an elastic member, the end effector having a grip driving portion and a grip mechanism portion configured to grip a part; the force detector configured to detect an external force exerted on the grip mechanism portion of the end effector, based on a deformation amount of the elastic member; an end effector controller disposed at the movable end of the arm and configured to control the grip driving portion of the end effector; and a robotic controller configured to control the motion of the arm.

### TECHNICAL FIELD

The present invention relates to a force control robot including a force detector and an end effector at an end portion of a robotic arm for performing tasks such as assembly of parts.

### BACKGROUND ART

In recent years, there is an increasing demand for automated assembly of products which are small in size and have complicated structures. For such products, it is necessary to perform assembly with complicated motions under accurate force control. Conventionally, in order to accurately and reliably assemble a gripped part, there has been proposed a force control robot provided with, at an end of a vertical articulated robotic arm, a robotic hand (an end effector) including a movable mechanism portion for gripping an object, and a force sensor. The force control robot controls the robotic arm and the robotic hand while the force sensor detects a force exerted on the robotic hand during assembly, to thereby perform accurate assembly of products having complicated structures. In a robot, such as the force control robot, which performs control using a sensor signal from a hand, a control circuit for a robotic hand is mounted on the robotic hand which is attached to an end of the robotic arm (see PTL1).

FIGS. 5A and 5B illustrate a conventional force control robot. FIG. 5A is an overall view of the force control robot. FIG. 5B is an enlarged view of an end portion of the force control robot of FIG. 5A. The force control robot includes a robotic arm 101, a robotic controller 105 for controlling the robotic arm 101, a force sensor 103, and an end effector 102. The force sensor 103 is attached on a movable end side of the robotic arm 101. The end effector 102 is attached to the robotic arm 101 through the force sensor 103. The force sensor 103 includes, for example, an elastic member and a displacement sensor for detecting a deformation amount of the elastic member. The end effector 102 includes a grip mechanism portion 102a for gripping an object, a driving portion 102b for driving the grip mechanism portion 102a, and an end effector controller 106 for drive-controlling the driving portion 102b. The driving portion 102b includes a servo motor serving as a drive source for operating the grip mechanism portion 102a. The end effector controller 106 is disposed on the driving portion 102b of the end effector 102. The end effector controller 106 includes a servo circuit for driving the servo motor and a signal processing circuit for processing a signal from the force sensor.

The robotic controller 105 drive-controls the robotic arm 101 based on an assembly operation program, to thereby operate the robotic arm 101. Further, the robotic controller 105 sends instructions about operation such as force, speed, and position to the end effector controller 106, to thereby operate the end effector 102.

Multiple electric wires 107 are provided as an electric wire member, which extends from an end arm frame 101a of the robotic arm 101 to the end effector 102. The electric wire member transmits a control signal between the end effector controller 106 and the robotic controller 105, and a detection value of the sensor, which has been signal-processed. Further, the electric wire member also plays a role to supply electric power, which is necessary for the end effector 102, from an electric source. The end effector controller 106 receives the instructions from the robotic controller 105 to drive the servo motor in the end effector 102. At this time, force generated between a part 121 and a workpiece 122 when the part 121 gripped by the end effector 102 is brought into contact with the workpiece 122 is detected as a deflection displacement amount of the elastic member of the force sensor 103. The robotic controller 105 corrects the motion of the robotic arm 101 based on the detected data, and thus the part 121 is assembled into the workpiece 122 in a state in which the force to be generated between the gripped part 121 and the workpiece 122 is adjusted.

As described above, damages of the part 121, the workpiece 122, the end effector 102, and the like are prevented, and the assembly is performed by inserting the part 121 which is gripped in good condition into the workpiece 122.

### CITATION LIST

### Patent Literature

PTL 1: Japanese Patent Application Laid-Open No. 563-312089

### SUMMARY OF INVENTION

### Technical Problem

However, in the conventional force control robot, the end effector controller is disposed on the end effector (the robotic hand) which is supported by the force sensor, and hence there exist the following unsolved problems.

That is, in the conventional force control robot, the end effector, the force sensor, and the robotic arm are connected to one another as one unit, and hence the end effector controller is mounted on the end effector. If the control circuit, the signal processing circuit for the force sensor, and the like are mounted on the end effector which is disposed far away from the gravity center of the robotic arm, a natural vibration frequency at the end of the end effector decreases, and a vibration during operation of the robot or a residual vibration which occurs when the operation is stopped becomes large in amplitude. The force sensor cannot perform accurate detection if the vibration is large in amplitude, and hence this has been a cause of deterioration in accuracy in assembly task by the force control robot.

Further, the electric wire member connected to the end effector controller may be dragged or wound around the robot due to a rotation or bending motion of a joint axis of the robotic arm. At this time, in some cases, large external force may be applied to the electric wire member. When external force is exerted on the electric wire member so that the electric wire member is pulled, the external force is transmitted from the end effector controller to the end effector, and hence the force sensor detects an unnecessary force component which is normally not desired to be detected. As a result, accurate detection cannot be performed by the force sensor, and this has been a cause of deterioration in accuracy in assembly task by the force control robot.

### Solution to Problem

The present invention has an object to provide a force control robot, which is capable of suppressing a vibration of the force control robot, suppressing detection of an unnecessary force component generated when, for example, an electric wire member is dragged, and detecting force which is exerted on an end effector during assembly by a robot with high precision, to thereby perform accurate assembly.

According to the present invention, there is provided a force control robot which controls a motion of a robotic arm based on a detection value of a force detector, the force control robot including: the robotic arm having one end serving as a fixed end and another end serving as a movable end; an end effector connected to the movable end of the robotic arm through an elastic member, the end effector having a grip driving portion and a grip mechanism portion configured to grip a part; the force detector configured to detect an external force exerted on the grip mechanism portion of the end effector, based on a deformation amount of the elastic member; an end effector controller disposed at the movable end of the robotic arm and configured to control the grip driving portion of the end effector; and a robotic controller configured to control the motion of the robotic arm.

Further, according to the present invention, there is provided a force control robot which controls a motion of a robotic arm based on a detection value of a force detector, the force control robot including: the robotic arm having one end serving as a fixed end and another end serving as a movable end; an end effector connected to the movable end of the robotic arm, the end effector having a grip driving portion, a grip mechanism portion configured to grip a part, and an end effector housing configured to support the grip driving portion through an elastic member;

the force detector configured to detect an external force exerted on the grip mechanism portion of the end effector, based on a deformation amount of the elastic member;

an end effector controller disposed at the end effector housing or the movable end of the robotic arm and configured to control the grip driving portion of the end effector; and

a robotic controller configured to control the motion of the robotic arm.

### Advantageous Effects of Invention

The force control robot according to the present invention may suppress the vibration occurring during operation of the robot or at the time of stoppage of the operation, because the end effector controller is mounted to a position closer to the gravity center of the robotic arm. As a result, an influence of an error caused by vibrations in a detection value of the force detector may be suppressed, and hence it is possible to perform complicated assembly by a high-accuracy force control.

Further, the present invention has a structure in which the external force received from the electric wire member connected to the end effector controller is not transmitted to the force detector, and hence force exerted on the end effector during assembly by the robot may be detected with accuracy. With this, complicated assembly may be achieved by a higher-accuracy force control.

Further features of the present invention will become apparent from the following description of exemplary embodiments with reference to the attached drawings.

### BRIEF DESCRIPTION OF DRAWINGS

FIG. 1A illustrates a force control robot according to a first embodiment of the present invention. FIG. 1A is a schematic overall view of the force control robot.

FIG. 1B illustrates a force control robot according to a first embodiment of the present invention. FIG. 1B is an enlarged view illustrating a movable end of a robotic arm and an end effector.

FIG. 2A is a view related to the first embodiment. FIG. 2A is a view illustrating a displacement center when the end effector is displaced.

FIG. 2B is a view related to the first embodiment. FIG. 2B is a view illustrating a modified example.

FIG. 3A illustrates a force control robot according to a second embodiment of the present invention. FIG. 3A is a schematic overall view of the force control robot.

FIG. 3B illustrates a force control robot according to a second embodiment of the present invention. FIG. 3B is an enlarged view illustrating a movable end of a robotic arm and an end effector.

FIG. 4 is a view related to the second embodiment, and is a view illustrating a displacement center when the end effector is displaced.

FIG. 5A illustrates a conventional force control robot. FIG. 5A is a schematic overall view of the force control robot.

FIG. 5B illustrates a conventional force control robot. FIG. 5B is an enlarged view illustrating a movable end of a robotic arm and an end effector.

### DESCRIPTION OF EMBODIMENTS

### First Embodiment

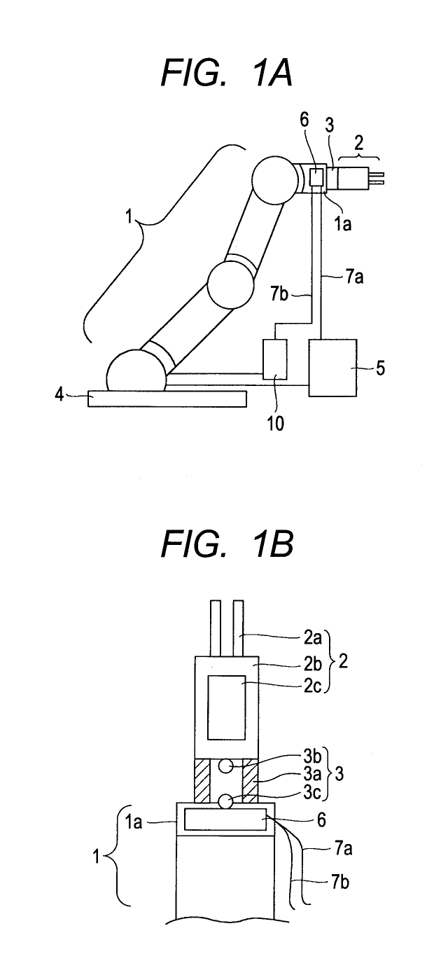

FIGS. 1A and 1B illustrate a force control robot according to a first embodiment of the present invention. As illustrated in FIG. 1A, a robotic arm 1 includes n (n is more than or equal to 1, n is an integer) joint axes, and the joint axes are connected to one another via a mechanical part such as an arm frame. The robotic arm 1 has one end serving as a fixed end and another end serving as a movable end. An end effector 2 and a force sensor 3 are disposed at the movable end. The fixed end is fixed to a pedestal 4. The movable end of the robotic arm 1 is connected to the end effector 2 through the force sensor 3. Each axis of the robotic arm 1 is defined as a first axis, a second axis, . . . , an (n−1)-th axis, and an n-th axis from the fixed end side, and an arm frame of the n-th axis constituting the movable end is referred to as an end arm frame 1a. The robotic arm 1 includes a power source such as a servo motor. In response to a control signal from a robotic controller 5 and by an electric power supply from an electric source 10, the servo motor is driven, to thereby drive-control each of the joint axes.

FIG. 1B is an enlarged view of an end portion of the articulated robot. The force sensor 3 is constituted by a displacement sensor (a force detector) configured to detect a relative displacement between a portion to be detected 3b and a displacement detection portion 3c opposite to each other, through an elastic member 3a. Positional relation between the portion to be detected 3b and the displacement detection portion 3c may be inverted from the arrangement illustrated in FIG. 1B.

The displacement sensor includes, for example, a non-contact magnetic sensor. By detecting a deformation amount of the elastic member 3a at a time when a grip mechanism portion 2a of the end effector 2 receives external force, as a relative displacement of the displacement detection portion 3c, force exerted on the grip mechanism portion 2a is detected as a displacement value.

The end effector 2 includes the grip mechanism portion 2a and a driving portion (a grip driving portion) 2b. A power source 2c configured to drive the grip mechanism portion 2a is provided in the driving portion 2b. The grip mechanism portion 2a is attachable to the driving portion 2b in a manner that grip mechanism parts having various forms are interchangeable depending on a part to be gripped. The driving portion 2b includes a mechanism configured to drive the grip mechanism portion 2a to perform a grip motion. Specifically, the driving portion 2b includes a mechanical mechanism such as gears or links for the driving, and an actuator. The grip mechanism portion 2a is, for example, a gripper configured to grip a part. A servo motor, for example, is adopted for the power source 2c.

The end arm frame 1a between the n-th axis of the robotic arm 1 and the elastic member 3a includes a support unit configured to support an end effector controller 6, which controls opening and closing of the end effector 2, on the fixed end side with respect to the elastic member 3a. The end effector controller 6 is electrically connected to an electric circuit in the end effector and the robotic controller 5.

The end effector controller 6 includes a drive control circuit for the power source 2c, and a signal processing circuit which receives an output (a detection value) of the force sensor 3 from the displacement detection portion 3c to perform signal processing. Further, the end effector controller 6 includes a communication circuit configured to communicate, to the robotic controller 5 via a control wire 7a, a drive pattern for driving the grip mechanism portion 2a and a result obtained by signal processing calculation of the output of the force sensor 3. The drive pattern instructed from the robotic controller 5 to the grip mechanism portion 2a may include, if the end effector 2 is, for example, a hand of a gripper type, instruction values of position, speed, force, and the like related to opening and closing of the gripper. A signal is transmitted through the control wire 7a through, for example, a differential serial signal protocol.

Further, the end effector controller 6 is provided with an electric power wire 7b for receiving an electric power from the electric source 10 provided outside. The electric power is consumed by the force sensor 3, the end effector 2, and the end effector controller 6 itself. Here, the control wire 7a and the electric power wire 7b are each illustrated as a single wire, but may be a wire group of two or more wires.

An operation sequence of the force control robot illustrated in FIGS. 1A and 1B, when a part gripped by the end effector 2 is assembled into a workpiece, is described below. The end effector controller 6 receives instructions about operation of the end effector 2 from the robotic controller 5, and the end effector controller 6 drives the servo motor in the end effector 2 based on the instructions. At this time, external force exerted on the end effector 2 when the part gripped by the end effector 2 is brought into contact with the workpiece is detected as a deflection displacement amount (a deformation amount) of the elastic member 3a of the force sensor 3. The robotic controller 5 corrects the motion of the robotic arm 1 based on the detection value, and thus the part is assembled into the workpiece while adjusting the force to be generated between the part gripped by the end effector 2 and the workpiece.

The force control robot performs such correction in drive-control, and hence damages of the gripped part, the workpiece, the end effector 2, and the like are prevented, and the assembly is performed by inserting the part which is gripped in good condition into the workpiece.

A feature of this embodiment resides in that the end effector controller 6 is not mounted on the end effector 2, but is mounted on the end arm frame 1a provided between the n-th axis of the robotic arm 1 and the elastic member 3a.

With this configuration, compared with the case where the end effector controller 6 is mounted on the end effector 2, the end effector controller 6 is provided nearer to the pedestal 4 on the fixed end side of the force control robot, and hence a decrease in natural vibration frequency at the end of the end effector is suppressed. Therefore, a vibration of the end effector 2, which causes a detection error of the force sensor 3, may be reduced, and hence accurate assembly may be performed. It is unnecessary to wait for oscillatory convergence, and hence operability of the robot is enhanced.

Further, the end effector controller 6 is supported by the end arm frame 1a provided between the n-th axis of the robotic arm 1 and the elastic member 3a. Therefore, external force, which is caused by dragging of the control wire 7a and the electric power wire 7b when the robotic arm 1 is moved, is not transmitted to the end effector 2. Further, any joints which are moved when the robotic arm 1 is moved are not provided between the end effector controller 6 and the end effector 2. Therefore, an electric wire connecting the end effector controller 6 and the end effector 2 to each other is neither pulled nor twisted, and hence force exerted on the assembly may be detected with greater accuracy. In other words, without newly adding a part such as a relay member configured to relay and hold electric wires such as the control wire 7a and the electric power wire 7b, and a protective member, a detection error of the force sensor due to the external force transmitted from the cables which cause the above-mentioned problems may be eliminated.

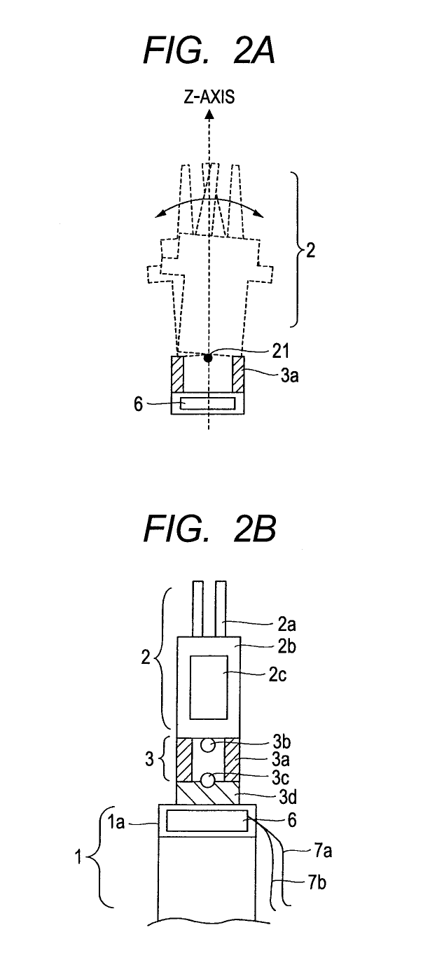

As illustrated in FIG. 2A, electrical parts of the end effector 2 and the end effector controller 6 are connected to each other via electric wires passing through an action center portion 21 in which a minimum positional displacement of the end effector 2 occurs with respect to the movable end of the robotic arm 1 when the external force is exerted on the end effector 2. When a straight line connecting a center of the end effector 2 and a center of a force sensor portion is defined as a Z-axis, in FIG. 2A, a point in which a contacting surface between the end effector 2 and the elastic member 3a and the Z-axis intersect each other is the action center portion 21. Here, an electric wire which electrically connects the end effector 2 to the end effector controller 6 in this manner is referred to as an end effector wire. The end effector wire actually includes multiple electric wires. When the end effector wire is connected to the end effector 2 in a state passing through the action center portion 21, an influence of force generated by a spring component of the electric wire, which causes a detection error of the force detector when the end effector 2 moves with the elastic member 3a acting as a fulcrum, may be suppressed. In other words, the force sensor 3 can detect force with further greater accuracy, and hence the accurate assembly may be achieved.

The end effector controller 6 may be attached to an exterior surface of the end arm frame 1a, or may be attached inside the end arm frame 1a having a hollow space therein. As a support unit configured to fix the end effector controller 6 to the end arm frame 1a, a groove configured to fix the end effector controller 6 may be formed in the end arm frame 1a. Alternatively, the end arm frame 1a and the end effector controller 6 may be fixed to each other by a screw or an adhesive, while interposing a member for fixation such as a spacer between the end arm frame 1a and the end effector controller 6. The end effector of this embodiment is a parallel gripper type end effector, but the present invention is not limited thereto. The end effector may be a multi-fingered universal hand including multiple joints and fingers, which is closer to a human hand.

As illustrated in FIG. 2B, even if a force sensor support member 3d configured to support the elastic member 3a is separately provided between the elastic member 3a and the end arm frame 1a, by disposing the end effector controller 6 at the end arm frame 1a, the same technical effects can be brought out.

### Second Embodiment

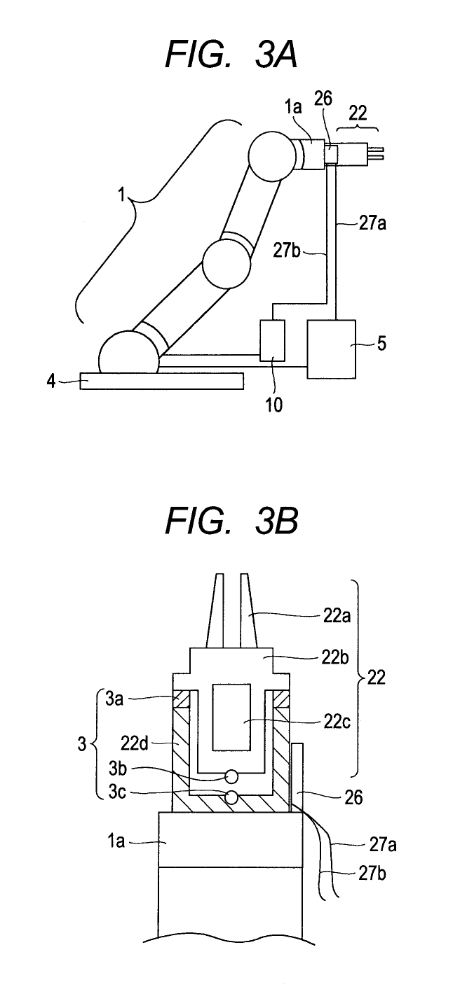

FIGS. 3A and 3B illustrate a force control robot according to a second embodiment of the present invention. As illustrated in FIG. 3A, the robotic arm includes n (n is more than or equal to 1, n is an integer) joint axes, and the joint axes are connected to one another via a mechanical part such as an arm frame. The robotic arm 1 has one end serving as a fixed end and another end serving as a movable end. The fixed end is fixed to the pedestal 4. An end effector 22 having a built-in force sensor is disposed at the movable end. Each axis of the robotic arm 1 is defined as a first axis, a second axis, . . . , an (n−1)-th axis, and an n-th axis from the fixed end side, and an arm frame of the n-th axis constituting the movable end is referred to as the end arm frame 1a. The robotic arm 1 includes a power source such as a servo motor. In response to a control signal from the robotic controller 5 and by an electric power supply from the electric source 10, the servo motor is driven, to thereby drive-control each of the joint axes.

As illustrated in FIG. 3B, the end effector 22 having the built-in force sensor includes a grip mechanism portion 22a configured to grip a part, a driving portion (a grip driving portion) 22b configured to drive the grip mechanism portion 22a, a power source 22c, and an end effector housing 22d. The force sensor includes the elastic member 3a, the portion to be detected 3b, and the displacement detection portion 3c, which are provided for converting force received by the end effector 22 at the grip mechanism portion 22a into a displacement value. The elastic member 3a is disposed between the driving portion 22b and the end effector housing 22d in the end effector 22. A straight line connecting a center of the grip mechanism portion 22a and a center of the force sensor 3 is defined as a Z-axis.

The grip mechanism portion 22a is attachable to the driving portion 22b in a manner that grip mechanism parts having various forms are interchangeable depending on a part to be gripped. The driving portion 22b includes a mechanism configured to drive the grip mechanism portion 22a to perform a grip motion. Specifically, the driving portion 22b includes a unit including a mechanical mechanism such as gears or links for the driving and an actuator. The force sensor 3 is constituted by a displacement sensor configured to detect, at the displacement detection portion 3c, a relative displacement between the portion to be detected 3b and the displacement detection portion 3c opposite to each other.

The portion to be detected 3b of the force sensor 3 is disposed on the driving portion 22b side of the end effector 22, and the displacement detection portion 3c is disposed on a bottom portion of the end effector housing 22d opposed to the portion to be detected 3b. Positional relation between the portion to be detected 3b and the displacement detection portion 3c may be inverted.

When a reaction force is exerted on a part when the end effector 22 grips the part for assembly, the force is transmitted to the grip mechanism portion 22a, and thus the driving portion 22b is displaced with the elastic member 3a acting as a fulcrum. For example, when the portion to be detected 3b is a magnetic output element and the displacement detection portion 3c is a magnetic detection element such as a Hall element, the displacement of the portion to be detected 3b due to the assembly reaction force is detected by the change in output of the displacement detection portion 3c. Accordingly, the magnitude and the direction of the assembly reaction force are detected.

The end effector 22 having the built-in force sensor includes the end effector housing 22d which is fixed to the movable end of the robotic arm 1. The elastic member 3a is disposed at a gravity center position of the driving portion 22b in the Z direction. Inertial force generated during the motion of the robotic arm 1 is mainly exerted on a portion summing the grip mechanism portion 22a and the driving portion 22b connected to the robotic arm 1 through the elastic member 3a. The grip mechanism portion 22a is satisfactorily smaller in mass compared with the driving portion 22b, and hence an influence to the gravity center position is small. Therefore, the following expression is satisfied: (a gravity center position of the grip mechanism portion 22a and the driving portion 22b) is substantially equal to (a gravity center position of the driving portion 22b).

In this embodiment, the end effector housing 22d fixe to the end arm frame 1a of the robotic arm 1 includes a support unit configured to support an end effector controller 26 on the fixed end side of the robotic arm 1 with respect to the elastic member 3a. The end effector controller 26 is electrically connected to the electric circuit in the end effector and the robotic controller 5. Note that, in this configuration, the end arm frame 1a may support the end effector controller 26.

The end effector controller 26 includes a drive control circuit for the power source 22c, and a signal processing circuit which receives an output of the force sensor 3 from the displacement detection portion 3c to perform signal processing. Further, the end effector controller 26 includes a communication circuit configured to communicate, to the robotic controller 5 via a control wire 27a, a drive pattern for driving the grip mechanism portion 22a and a result obtained by signal processing calculation of a force sensor portion. The drive pattern instructed from the robotic controller 5 to the grip mechanism portion 22a may include, if the end effector 22 is, for example, a hand of a gripper type, instruction values of position, speed, force, and the like related to opening and closing of the gripper. A signal is transmitted through the control wire 27a by, for example, a differential serial signal protocol.

Further, the end effector controller 26 is provided with an electric power wire 27b configured to receive an electric power from the electric source 10 provided outside. The electric power is consumed by the force sensor 3, the end effector 22, and the end effector controller 26 itself. Here, the control wire 27a and the electric power wire 27b are each illustrated as a single wire, but may be a wire group of two or more wires.

An operation sequence of the force control robot according to this embodiment, when a part gripped by the end effector 22 is assembled into a workpiece, is described below. The end effector controller 26 receives instructions about operation of the end effector 22 from the robotic controller 5. The end effector controller 26 drives the servo motor in the driving portion 22b based on the instructions. At this time, force generated between the part and the workpiece when the part gripped by the grip mechanism portion 22a is brought into contact with the workpiece is detected as a deflection displacement amount (a deformation amount) of the elastic member 3a. The robotic controller 5 corrects the motion of the robotic arm 1 based on the detection value, and thus the robotic controller 5 assembles the part into the workpiece while adjusting the force to be generated between the part gripped by the end effector 22 and the workpiece. As described above, the damages of the gripped part, the workpiece, the end effector 22, and the like are prevented, and the force control robot performs assembly by inserting the part which is gripped in good condition into the workpiece.

This embodiment can achieve the same technical effects as those of the first embodiment, and additionally, a great distance may be ensured from the fulcrum of deformation of the driving portion 22b, the deformation being generated due to the deformation of the elastic member 3a, because the elastic member 3a is disposed near the grip mechanism portion 22a. Therefore, compared with the case of the stacked structure in which the force sensor supports the end effector, the end effector itself may be reduced in size. Owing to the reduction in size, the vibration of the grip mechanism portion 22a at the end of the robotic arm may be suppressed, and the displacement at the force sensor portion may be increased without lowering the detection sensibility. Further, there is no need to decrease the rigidity of the elastic member 3a because the sufficiently increased displacement is ensured. Therefore, it is possible to achieve both size reduction and speedup.

The gravity center position of the driving portion 22b coincides with the deformation fulcrum of the elastic member 3a, and hence it is possible to minimize the influence of the moment, which is produced by the positional difference between the deformation fulcrum of the elastic member 3a and the gravity center position of the driving portion 22b, on the force sensor portion. With this structure, it is possible to shorten the static time for positioning of the portion to be detected 3b and the displacement detection portion 3c when the robotic arm 1 is moved and to speed up the detection of the force sensor 3.

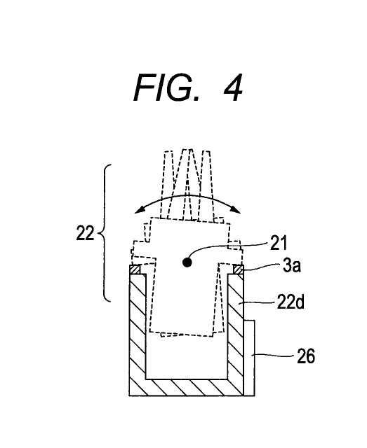

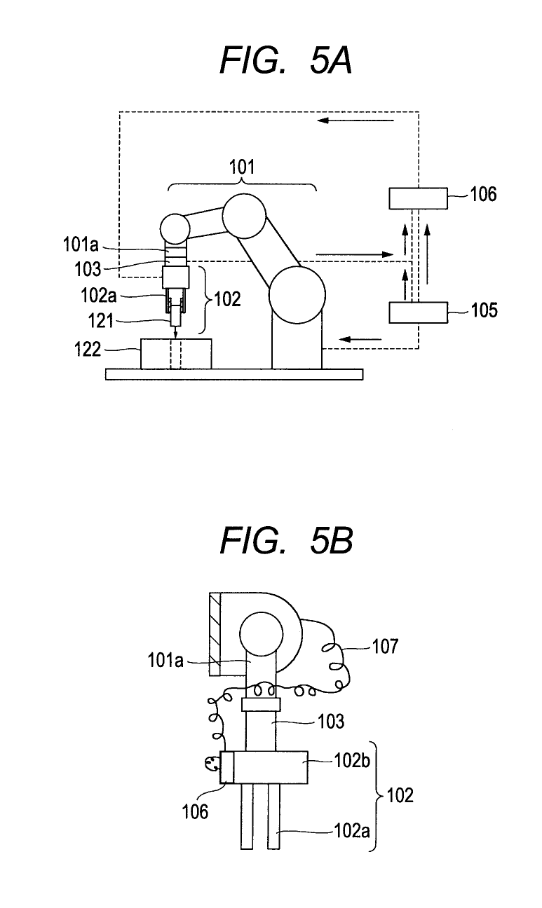

As illustrated in FIG. 4, when the external force is received by the grip mechanism portion 22a, a portion at which the minimum positional displacement of the grip mechanism portion 22a with respect to the end effector housing 22d occurs is referred to as the action center portion 21. In FIG. 4, the action center portion 21 corresponds to a gravity center of the driving portion 22b. Here, an electric wire which electrically connects an electric circuit and an electric part, such as the servo motor, which are mounted in the driving portion 22b, to the end effector controller 26 in a state passing through the action center portion 21 is referred to as an end effector wire. The end effector wire actually includes multiple electric wires. When the end effector wire is connected to the driving portion 22b in a state passing through the action center portion 21, an influence of fluctuation in force generated by a spring component of the electric wire, which causes a detection error of the force sensor 3 when the driving portion 22b moves with the elastic member 3a acting as a fulcrum, may be suppressed. In other words, the force sensor 3 can detect the force with greater accuracy, and hence accurate assembly may be achieved.

In the first and second embodiments, the number of the grip mechanism parts of the grip mechanism portion of the end effector is not limited to two as long as the end effector may grip a part. Further, the driving portion of the end effector may include any driving sources (of the electromagnetic type, the air compression type, and the like) and any mechanism portions (gears, links, and the like) as long as the driving portion is a drive mechanism which enables gripping with the grip mechanism portion. The material and the configuration of the elastic member are not limited as long as the elastic member is capable of causing the end effector to be displaced, and the elastic member may be a unit including combined multiple parts. Although a Hall element is assumed as the force sensor portion, any sensor such as a laser displacement gauge and an eddy-current sensor may be used as long as the sensor can detect the relative displacement. Further, detection along six axes may be obtained by changing the number and positions of the detection elements.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-068015, filed Mar. 24, 2010, which is hereby incorporated by reference herein in its entirety.

1. A force control robot which controls a motion of a robotic arm based on a detection value of a force detector, the force control robot comprising:
the robotic arm having one end serving as a fixed end and another end serving as a movable end;
an end effector connected to the movable end of the robotic arm through an elastic member, the end effector having a grip driving portion and a grip mechanism portion configured to grip a part;
the force detector configured to detect an external force exerted on the grip mechanism portion of the end effector, based on a deformation amount of the elastic member;
an end effector controller disposed at the movable end of the robotic arm and configured to control the grip driving portion of the end effector; and
a robotic controller configured to control the motion of the robotic arm.

2. A force control robot according to claim 1, wherein the end effector controller is electrically connected to an action center portion of the end effector, the action center portion being a portion in which a displacement of the end effector when the grip mechanism portion receives the external force is small.

3. A force control robot which controls a motion of a robotic arm based on a detection value of a force detector, the force control robot comprising:
the robotic arm having one end serving as a fixed end and another end serving as a movable end;
an end effector connected to the movable end of the robotic arm, the end effector having a grip driving portion, a grip mechanism portion configured to grip a part, and an end effector housing configured to support the grip driving portion through an elastic member;
the force detector configured to detect an external force exerted on the grip mechanism portion of the end effector, based on a deformation amount of the elastic member;
an end effector controller disposed at the end effector housing or the movable end of the robotic arm and configured to control the grip driving portion of the end effector; and
a robotic controller configured to control the motion of the robotic arm.
